(19) United States
(12) Patent Application Publication
(10) Pub. No.: US 2019/0275411 A1
(43) Pub. Date: Sep. 12, 2019

(54) Remote Gaming Platform

(71) Applicants: Miranda Hansen, Issaquah, WA (US); Joshua Cummings, Pullman, WA (US); John Barth, Prosser, WA (US)

(72) Inventors: Miranda Hansen, Issaquah, WA (US); Joshua Cummings, Pullman, WA (US); John Barth, Prosser, WA (US)

(21) Appl. No.: 16/298,115

(22) Filed: Mar. 11, 2019

Related U.S. Application Data
(60) Provisional application No. 62/680,727, filed on Jun. 5, 2018.
(60) Provisional application No. 62/641,392, filed on Mar. 11, 2018.

(51) Int. Cl. A63F 3/00; A63F 13/33; A63F 13/213; A63F 13/214; A63F 13/843

(52) U.S. Cl. CPC A63F 3/00643; A63F 3/00574; A63F 3/00694; A63F 13/33; A63F 13/213; A63F 2003/00662; A63F 13/843; A63F 2003/00182; A63F 2003/00337; A63F 2003/00391; A63F 2003/0063; A63F 13/214

(57) ABSTRACT

The object of the invention is to provide a system that will allow multiple participants in remote locations to participate in a board game. The disclosure presented herein relates to a remote gameplay platform. Multiple instances of the platform may be combined to form a platform network, or a platform may be combined with virtual instances of the platform that would allow remote users to physically manipulate the board from remote locations.

### CROSS-REFERENCE TO RELATED APPLICATIONS

This application claims priority to U.S. Provisional Application No. 62/641,392 filed on Mar. 11, 2018 and U.S. Provisional Application No. 62/680,727 filed on Jun. 5, 2018. The content of the above applications are incorporated by reference in their entirety.

### FIELD OF THE DISCLOSURE

The overall field of invention relates to the field of board and tabletop games for remote gameplay including dynamic item tracking and physical manipulation of remote game items.

### BACKGROUND

Board games are typically played by a group of two or more players on a single playing surface such as a tabletop board or map. Items such as game pieces or markers are placed by individual players on the playing surface and moved or manipulated throughout the course of gameplay.

Because of the physicality involved in moving items, players of traditional board games must be physically present in the same locale as the playing surface. Often, groups of players who desire to play together cannot do so because a player is not able to be physically present at the playing surface location.

The limitation that all players must be in the same location can be problematic for a variety of reasons. Often, groups of players will prefer to play together on regular or semi-regular bases, and the absence of a given player can disrupt tradition. Similarly, the issue can be problematic for games with lengthy campaigns that may take place over extended periods, a common occurrence with role-playing games. In these cases, it can be important for all of the players to be present for each gameplay session, and absence of any given player can interrupt or derail a campaign.

Groups that have been physically separated have attempted to solve this issue through use of remote communication. Typically, a single board will be set up in a location, and remote users will have virtual presence, as in a video conference. Remote players would rely on local players to do any physical tasks related to gameplay, such as drawing cards or moving items. While this type of gameplay can be functional, it significantly detracts from the gameplay experience. In other cases, physically separated groups have resorted to playing virtual or simulated versions of the games on display screens without any physical gaming surface or physical markers. Online chess is a good example of this type of play. For many players and groups, however, the elimination of the physical board and markers is detrimental to their enjoyment and can potentially limit gameplay.

A need exists for a system that will allow tabletop game players to participate in a game from remote locations. The goal of this invention is to provide multiple instances of a single game with live syncing such that every instance remains essentially identical to every other instance. Such a system would allow players at remote locations to freely interact with a board game and with one another through remote gameplay.

### SUMMARY

The object of the invention is to provide a system that will allow multiple participants in remote locations to participate in a board game. The disclosure presented herein relates to a remote gameplay platform. Multiple instances of the platform may be combined to form a platform network, or a platform may be combined with virtual instances of the platform that would allow remote users to physically manipulate the board from remote locations.

A platform comprises a playing surface, camera system for image recognition, a positioning system for item manipulation, and a processor combined with transient memory for system and network integration.

A platform will recognize a playing surface, markers placed thereon, and states thereof, through a camera system comprising cameras, processors, and memory devices. A player can move an item on the playing surface, and the camera system will recognize that move. Similarly, a player may change the state of the playing surface, and the camera system will recognize that change.

A platform positioning system is capable of physically manipulating items and item locations on the playing surface. The positioning system is comprised of a 2D positioner and an effector head capable of grasping an item, moving, and releasing the item. Users may command the positioner to grasp an item and move the item to a different location.

When the platform is networked with a virtual instance, the virtual instance will display the playing surface in a remote location and allow a remote user to command the platform to move an item, typically via a graphic user interface. Alternatively, multiple instances of the platform may be networked together. In this configuration, users may command item movement in remote locations by simple movement of an item on the local platform.

If the configuration status changes for one platform in a platform network, the platform camera system will detect that change, generate movement command data, and when networked with other platforms, will relay the movement command data to other platforms in the network, which will then physically reproduce that change.

In this configuration, the invention will allow a first player to physically move a first item on a first gaming surface in a first location and have that move be reproduced by a similar second item on a similar second gaming surface in a second remote location. Similarly, a second player could move an item at the second location to have the move reproduced by a similar item at the first location. A system of this type will effectively collect item and board configuration status for each location instance and sync that configuration status with other instances of the game. When a plurality of platforms are networked, the platform network has the capability of detecting the configuration of any given playing surface and items placed thereon, and syncing or reproducing that configuration on every other platform in the network.

Furthermore, the camera system has the capability to recognize things other than items. The platform has optical object recognition capability, which can be used to detect markings that are drawn on the playing surface. The drawn markings can then be reproduced on other networked platforms by having the effector-head grasp an item adapted for marking and moving it across the playing surface. By this method, the network is able to reproduce a given drawn map in every location. Similarly, remote users of virtual instances can command the platform to draw maps from their remote locations via the remote user interface.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 shows a view of a remote gaming platform.

FIG. 2 shows a view of a positioning system.

FIG. 3 shows a side view and cutaway view of an embodiment of the effector head.

FIG. 4 shows an isometric view of an embodiment the effector head with hidden lines shown as dashed.

FIG. 5 shows a side view and a cutaway view of an embodiment of the effector head having a permanent magnet.

FIG. 6 shows an isometric view of an embodiment the effector head having a permanent magnet with hidden lines shown as dashed.

FIG. 7 shows a side and section view of an item.

FIG. 8 shows a top view of the item.

FIG. 9 shows a schematic of a network of remote gaming platforms.

FIG. 10 shows a flowchart for an item position sync subroutine.

### DEFINITIONS

Item: A moveable physical piece, such as a gamepiece, marker, drawing tool, or other part adapted for placement and use on the playing surface.
Playing surface: A substantially planar surface adapted to hold recreational gaming items.
Platform: playing surface, camera system, positioning system, and control system
Physical instance: a physical example of the platform
Virtual instance: a virtual example of the platform having virtual representations of the playing surface, items, and other features such as markings or maps.
Generic instance: either a physical instance or a virtual instance.
Platform state data: data related to item position, camera system data, and positioner system data.
Unique optical identifier: An identifier visible to a camera system that provides unique identification of an item associated with said, such as a barcode, QR code, or other similar identification means.

### DETAILED DESCRIPTION

The disclosure presented herein relates to a remote gaming platform. As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

While preferred and alternate embodiments have been illustrated and described, as noted above, many changes can be made without departing from the spirit and scope of the nesting deterrence device. Accordingly, the scope of the remote gaming platform is not limited by the disclosure of these preferred and alternate embodiments. Instead, the scope of the remote gaming platform should be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents that are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶6. In particular, the use of “step of” in the claims herein is not intended to invoke the provisions of U.S.C. § 1129 ¶6.

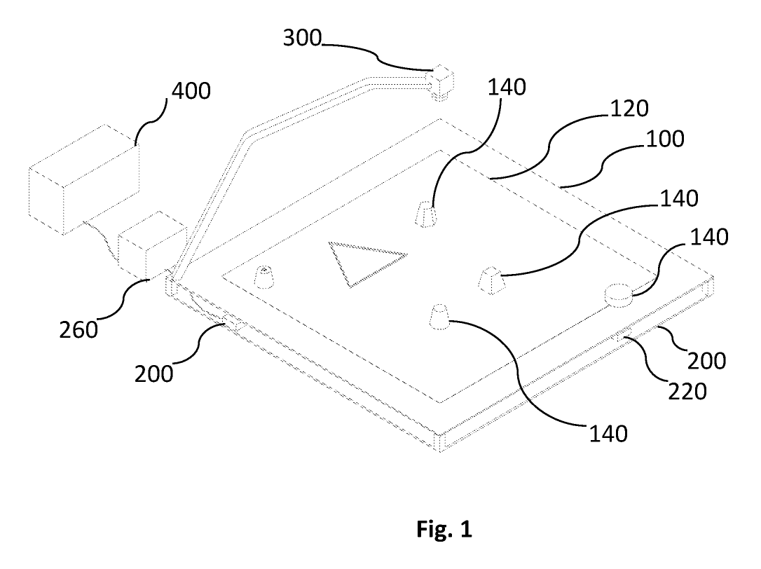

FIG. 1 shows a view of a remote gaming platform. The platform comprises a playing surface 100, a positioning system 200, a camera system 300, and a control system 400. The playing surface 100 is essentially a planar surface. The playing surface 100 is adapted to support a map 120 and items 140. The playing surface is adapted to work with a positioning system 200. The positioning system 200 is a system of at least two actuators 220 and an effector head. The effector head is magnetic and is capable of magnetically grasping and releasing items 140. The positioning system actuators 220 operate to position the effector head at desired locations under the playing surface 100. The playing surface 100 is dimensionally thin in the direction normal to the playing surface and comprised of a non-ferromagnetic or other magnetically transparent material, thereby allowing the magnetic effector head to magnetically grasp an item 140 that is placed on the playing surface 100 when the effector head is positioned immediately below the item.

The control system 400 operates to integrate data collected by the camera system 300, positioner 200 data, data supplied by additional networked instances, and stored data using a microprocessor in combination with transient memory and a processor program. The control system is capable of receiving data inputs from a local instance camera system 300 and positioner system 200 as well as similar data from other remote instances, to process the data, output move command data to the positioner control 260, and transmit local instance data to other network instances.

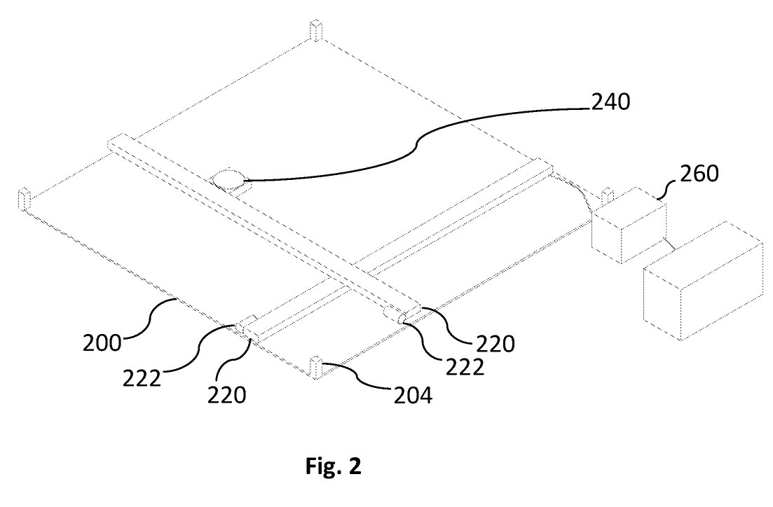

FIG. 2 shows a view of the positioning system 200. In the preferred embodiment, the positioning system is fixed on a baseboard 202. Extending from the baseboard are supports 204 that support the playing surface 100 above the positioning system 200. The actuators 220 are arranged and attached in a manner that provide for 2D positioning of the effector head 240. In the preferred embodiment, actuators 220 are linear actuators that are arranged orthogonally to provide a simple XY positioning system. Linear actuators may be any of a wide variety of actuators including but not limited to lead screw, ball screw, roller screw, rack-and-pinion, belt drive, cable drive, helical band, rigid belt, rigid chain, segmented spindle, or any other linear actuator type. In alternative embodiments, rotational actuation may be combined in series or with linear actuation to provide planar positioning. In alternative embodiments, 2D positioning may be achieved via a cable system, wherein cables or cords extend from points outside of the envelope of the playing surface to the effector head, and the length of the cables or cords can be controlled to define the position of the effector head through triangulation. Any positioner system capable of controlling the head within a plane should suffice.

The positioner controller 260 is adapted for controlling actuator motors 222. Actuator motors 220 may be servo motors, stepper motors, or any other motor capable of controlled motion. The actuator motors 222 drive the actuators and provide 2D positioning of the effector head 240. The effector head 240 is capable of controlling a magnetic field that extends through the playing surface 100. In the preferred embodiment, the effector head 240 is electromagnetic. When electric current is supplied to electrical coils at the effector head, a magnetic field results. In the preferred embodiment, the electric current can be controlled to produce magnetic fields of varying strength. In alternative embodiments, the current may be controlled to be in binary on or off states. In other embodiments, the magnetic field is produced by a permanent magnet, and the degree to which the magnetic field extends through the playing surface is controlled by actuating the magnet toward or away from the playing surface. In this manner, the effector head may move proximal to the 2D coordinate position of an item 140 and grasp the item by actuating the permanent magnet. Similarly, the effector head could release by actuating the permanent magnet away from the playing surface. In alternative embodiments, grasping and releasing items may be achieved by altering the orientation of the magnet, by shunting the magnetic field, or by other means for controlling magnetic field.

In an embodiment, the magnetic field may be controlled to non-binary states for varying purposes. A magnetic field has a “grasping” state, used for moving or dragging an item across the playing surface. The magnetic field will also have a “free motion” state, for use in moving the effector head beneath the playing surface without interaction with items. In alternative embodiments, the magnetic field will have one or more “actuation” states that can be used to actuate items and achieve some desired effect.

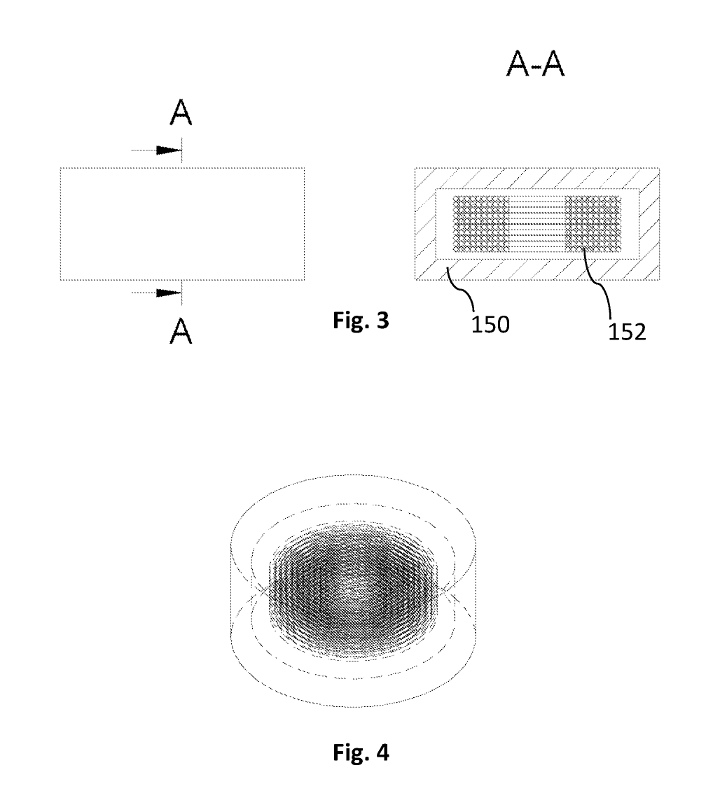

FIG. 3 shows a side view and cutaway view of an embodiment of the effector head. The embodiment of the effector head is based on an electromagnet and is comprised of a body 150 and conductive coils 152. When electric current flows through the conductive coils, a magnetic field results.

FIG. 4 shows an isometric view of the electromagnetic effector head with hidden lines shown as dashed.

FIG. 5 shows a side view and a cutaway view of an embodiment of the effector head having a permanent magnet. The embodiment of the effector head is comprised of a body 170, a permanent magnet 172, and a magnet actuator 174. In the embodiment, the actuator serves to move the permanent magnet 172 toward or away from the effector face 176. When the actuator 174 actuates the permanent magnet 172 to a position proximal to the effector face 176, the permanent magnet 172 magnetic fields will significantly extend upward through the effector face 176. When the actuator 174 actuates the permanent magnet 172 downward away from the effector face 176, the magnetic field will not permeate the face to a significant degree.

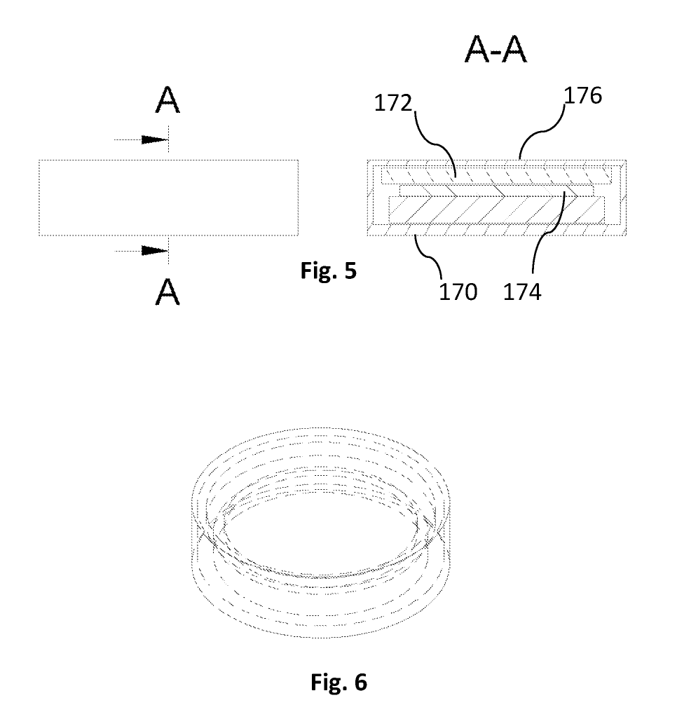

FIG. 6 shows an isometric view of an embodiment the effector head having a permanent magnet with hidden lines shown as dashed.

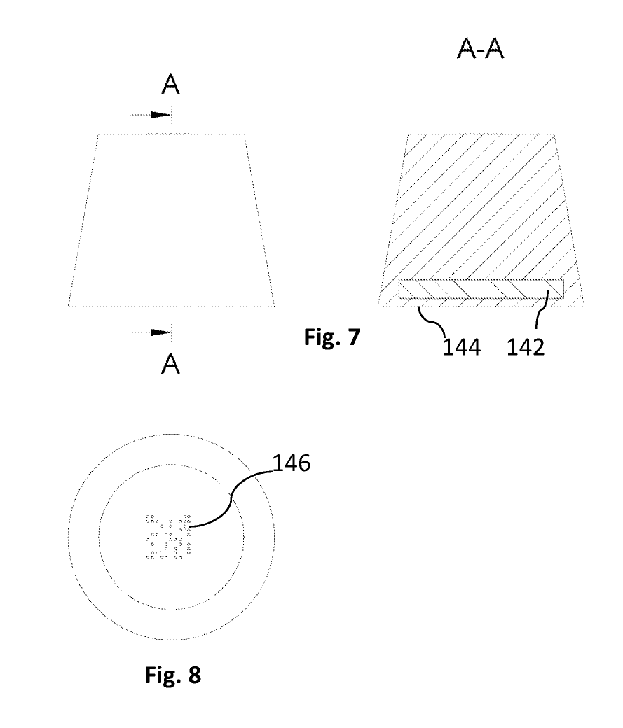

FIG. 7 shows a side and section view of an item 140. In order to interact with the effector head, items incorporate magnetic elements 142, such as permanent magnets or ferromagnetic elements. In the preferred embodiment the magnetic elements 142 are fixed proximal to the base 144 of the items 140. In an embodiment, the magnetic element is molded into the item integrally. In alternative embodiment, magnetic elements may be affixed to the item with adhesive or other mechanical attachment.

FIG. 8 shows a top view of the item 140. In the preferred embodiment, each marker will have a unique visual signature. In an embodiment, a unique visual signature may simply be the physical form of the marker with attendant contours or other visible identifiers, such as color. In an embodiment, an identifier 146 adapted to provide the unique visual signature is printed, embossed, molded, or otherwise affixed to the items. The identifier 146 may be a QR code, barcode, or any other identifying element that is capable of uniquely identifying an item.

Items may be markers, such as game pieces that are typically used in board games and moved about the playing surface to track play progression. Items may also have other purposes or functions. In an embodiment, an item may be a drawing tool. A drawing tool may be used to create markings on the map. A drawing tool will have a marking point for depositing ink or other marking media. In an embodiment, a drawing tool will deposit ink along any path across which it is moved. In alternative embodiments, a drawing tool will have a mechanism to control the marking media, such that the magnetic field of the effector head can be modulated to cause the marking point to move in or out of contact with the map, thereby controlling whether marking media is deposited on the map as the drawing tool is moved across the playing surface.

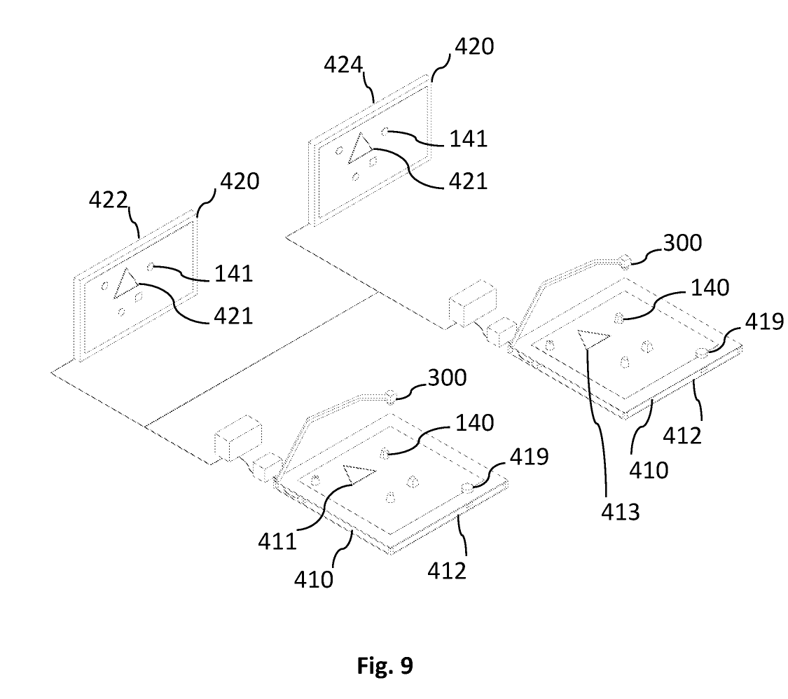

FIG. 9 shows a schematic of a network of remote gaming platforms. The platform is designed to work in a system of a plurality of networked platforms. In the schematic shown, the platform network is comprised of physical instances 410 and virtual instances 420. The physical instances are a first platform 412 and a second platform 414. The virtual instances are a first virtual instance 422, and a second virtual instance 424. Theoretically the platform network may comprise at least one physical instance 410 and any number of additional physical 410 or virtual instances 420. In this configuration, the virtual instances 420 will render the board state at a physical instance 410, as well as accept commands to move items 140 at the physical instances 410. Similarly, each physical instance 410 receives commands to move items. A command at a physical location may be generated by a user simply moving an item 140 by hand. When a user moves the item in this manner, the camera system 300 will detect the movement and transmit corresponding move command data to other physical or virtual instances, which will then reproduce the move.

In the networked configuration, all instances should have matching items. Each physical instance 410 should have similar items 140, and each virtual instance should have similar representative virtual items 141.

The system is adapted to allow a user to draw on their local map and to have those drawings 411 be reproduced at remote instances. The drawing tool 419 allows users to draw on other remote instances. When drawing a user's local map, however, the user may simply draw on the map with a pen, marker, or the like. The local instance camera system will recognize the drawing 411 and send command data to remote instances to create reproduction drawings on the remote maps. In the case of remote physical instances, the drawing is reproduced using the drawing tool 419, while on remote virtual instances 420, the virtual drawing 421 is reproduced via the graphical user interface.

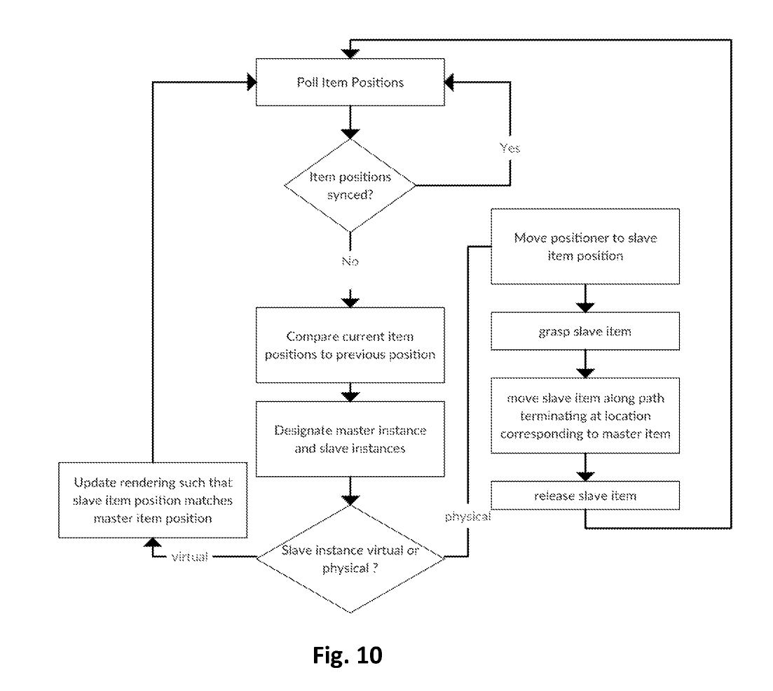

FIG. 10 shows a flowchart for an item position sync subroutine. Item syncing occurs in all network configurations, including networks having virtual items. Every item location is polled to determine whether all corresponding items are in a synced state. If, upon polling, the system recognizes that there is a non-synced state due to an instance having an item location that differs from corresponding remote items, the differing instance will become the master instance, and all other instances will be slaved to that instance until location sync is complete. Item positions for the master instance are recorded and corresponding move command data is generated. The move command data is transmitted across the network to all other instances. If a slave instances is a physical instance, the move at a physical instance is achieved by the camera system recognizing item location, the positioner moving the effector head to that location, the effector head magnetically grasping the item, the positioner translating the item along a path that terminates at the desired location, and the effector head releasing the item. Upon release, the move replication is complete, and the position states are synced. Polling of item location resumes. If the slave instance is a virtual instance, the slave will receive move command data an update the virtual platform rendering to reflect the move. Upon updated rendering, polling resumes.

In an embodiment, drawing or marking sync state is also polled in a manner similar item location. Drawings are reproduced through a subroutine similar to the basic item sync subroutine. Drawing tools may be multiple and varied at a given instance, such that drawings having more than one color or line-type could be created.

While preferred and alternate embodiments have been illustrated and described, as noted above, many changes can be made without departing from the spirit and scope of the invention. Accordingly, the scope of the invention is not limited by the disclosure of these preferred and alternate embodiments. Instead, the scope of the invention should be determined entirely by reference to the claims. Insofar as the description above and the accompanying drawings disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶6. In particular, the use of “step of” in the claims herein is not intended to invoke the provisions of U.S.C. § 112 ¶6.

We claim:

1. A remote gaming platform system comprising:
a playing surface,
a camera system having a camera positioned above and having view of said playing surface, said camera system being adapted for optical recognition of an item placed in view of the camera;
a positioner system comprising a magnetic effector head positioned below and connected to said playing surface, a positioner controller capable of commanding positioner system movement, an actuator, and an actuator motor, said positioner system being adapted to move said effector head to a plurality of positions in a plane substantially parallel to said playing surface, said magnetic effector head being adapted to magnetically grasp said item on said playing surface, and
a control system adapted for integration of said camera system and said positioner system, said control system comprising a processor operating in combination with transient memory and a processor program for system and network integration, said control system being configured to receive, process, and store platform state data supplied by said camera system and said positioner system on a computer readable medium, and to send said platform state data to a connected generic instance.

2. The system of claim 1 wherein said optical recognition occurs through recognition of a unique optical identifier associated with an item.

3. The system of claim 1 wherein said positioner system further comprises two linear actuators arranged orthogonally and adapted for orthogonal two-dimensional positioning of said magnetic effector head.

4. The system of claim 3 wherein said magnetic effector head further comprises an electromagnet.

5. The system of claim 4 wherein said electromagnet is controllable to at least two magnetic field states.

6. The system of claim 5 wherein at least one item has a marking point adapted to deposit marking media on said playing surface.

7. The system of claim 6 wherein said marking point is controllable to move into and out of contact with said playing surface through magnetic actuation.

8. The system of claim 1 further comprising a second generic instance of a remote gaming platform in network connection with said control system, wherein said network connection allows transmission of platform state data between generic instances.

9. The system of claim 8 wherein said second generic instance of a remote gaming platform is a second physical instance similar to said first physical instance.

10. The system of claim 8 wherein said second generic instance of a remote gaming platform is a virtual instance.

11. A method for remote gameplay comprising:
a. positioning one or more items atop a playing surface at a first physical instance of a remote gameplay platform,
b. networking said first physical instance with at least one additional generic instance of remote gameplay platform,
c. using a camera system to produce item position data for said first physical instance;
d. storing said item position data in one or more memory devices,
e. comparing item position data between generic instances to determine whether said item positions are synced between said generic instances,
f. designating a master instance having a master item and a slave instance having a slave item,
g. moving a positioner to correspond to a location corresponding to a non-synced slave item,
h. positioner grasping said non-synced slave item,
i. positioner moving said non-synced slave item to a position corresponding to said master item, and
j. positioner releasing said slave item.
